(19) United States
(12) Patent Application Publication
(10) Pub. No.: US 2020/0383308 A1
(43) Pub. Date: Dec. 10, 2020

(54) CULLING CLIP AND SYSTEM FOR USE THEREWITH

(71) Applicant: Dwayne Michael BRAME, Battersea (CA)

(72) Inventor: Dwayne Michael BRAME, Battersea (CA)

(21) Appl. No.: 16/895,911

(22) Filed: Jun. 8, 2020

Related U.S. Application Data
(60) Provisional application No. 62/858,378, filed on Jun. 7, 2019.

(51) Int. Cl. A01K 97/14; F16B 2/06

(52) U.S. Cl. CPC A01K 97/14; A01K 61/95; F16B 2/06

(57) ABSTRACT

A culling clip is for use with fish. The culling clip includes a culling clip body, lower clamp arm, an upper clamp arm and a locking mechanism. The culling clip body has an open position and a closed position. The culling clip body includes an upper arm and a lower arm spaced therefrom. The lower clamp arm extends inwardly from the end for the lower arm and has a lower clamp arm distal end. The upper clamp arm extends inwardly from the end of the upper clamp arm and has an upper clamp arm distal end. The lower clamp arm distal end is spaced from the upper clamp arm distal end when the culling clip body is in the closed position. The locking mechanism is for holding the culling clip body in the closed position. The culling clip is considered in the no-harm non-penetrating category of culling clips.

### FIELD OF THE DISCLOSURE

This disclosure relates to clips for use with fish and in particular culling clips that may be used in fishing competitions as well for sorting fish in a livewell system.

### BACKGROUND

In 2018 the Bass Anglers Sportsman Society (BASS), and the Fishing League Worldwide (FLW) bass fishing organizations had introduced a regulation that made it illegal to use any culling system which injures or harm the bass in any way. This policy has led to many anglers to look for alternatives to the standard culling system that utilized a wire poking through the skin of the lower jaw and creating a clasp onto which an identification marker was attached. To date there are many alternative culling systems that utilize clamping systems that pinch down on the lower jaw of the bass. Some culling systems use large levers with extended handles that are very heavy and either slip from the lower jaw bone of the fish or, they are so tightly clamped that the skin inside and or the lower jaw bone is destroyed. Other culling systems use small pinching metal clips that damage the jaw bone and skin of the fish. No culling clamping system to date has truly upheld the purpose of the non-piercing regulation of culling systems, not injuring the fish in any manner.

It would be advantageous to provide a culling clip and system for use therewith that is easy to use and reduces or eliminates injuries or harm to the fish.

### SUMMARY

The present disclosure relates to a culling clip for use with fish. The culling clip includes a culling clip body, lower clamp arm, an upper clamp arm and a locking mechanism. The culling clip body has an open position and a closed position. The culling clip body includes an upper arm and a lower arm spaced from the upper arm. The lower clamp arm extends inwardly from the lower arm at an end thereof and the lower clamp arm has a lower clamp arm distal end. The upper clamp arm extends inwardly from the upper clamp arm at an end thereof and the upper clamp arm has an upper clamp arm distal end. The lower clamp arm distal end is spaced from the upper clamp arm distal end when the culling clip body is in the closed position. The locking mechanism is for holding the culling clip body in the closed position.

The culling clip body may be generally elongate C-shaped.

The upper clamp arm may be longer than the lower clamp arm.

The culling clip may include an upper clamp arm soft material cover over the upper clamp arm and a lower clamp arm soft material cover over the lower clamp arm.

The upper clamp arm soft material cover may be a sleeve and the lower clamp arm soft material cover may be a sleeve.

The upper clamp arm and the lower clamp arm may each have a plurality of posts extending outwardly to hold the upper clamp arm soft material cover and the lower clamp arm soft material cover in place.

The locking mechanism may include a locking clasp arm that extends inwardly from one of the upper arm and the lower arm and engages the other of the upper arm and lower arm. The locking clasp arm may be spaced inwardly from the lower clamp arm distal end and the upper clamp arm distal end. The locking clasp arm may hold the culling clip body in the closed position.

The locking mechanism may further include a thumb slide for disengaging the locking clasp arm.

The culling clip body may be made from resiliently deformable material and wherein the culling clip body returns to the open position.

A bobber assembly may be attachable to the culling clip body. The bobber assembly may include a bobber body and a removably attachable bobber label.

The bobber body may be tapered as it extends downwardly. The bobber label may be one of glow-in-the-dark and fluorescent material.

The culling clip body may include an attachment ring and the bobber assembly may include a lanyard attached between the bobber body and an attachment device. The attachment device may be attachable to the attachment ring.

The bobber assembly attachment device may include a split ring.

The bobber assembly may be attachable to a weigh scale.

The culling clip body may be attachable to a weigh scale.

The weigh scale may be a balance beam weigh scale for determining the relative weight between two fish attached at either end of the weigh scale.

The balance beam weigh scale may have a balance beam with a lanyard slot and bobber saddle for receiving the bobber assembly at each end thereof.

The culling clip body may be attachable to a weigh scale.

The balance beam may have a clip seat for receiving the culling clip body at each end thereof.

A balance beam weigh scale is for determining the relative weight between two fish attached at either end thereof. The balance beam weigh scale includes a handle and a balance beam pivotally attached to the handle. The beam is equally balanced on either side of the pivot. The balance beam has a clip seat for receiving a culling clip at each end thereof.

The balance beam may further include a lanyard slot and bobber saddle for receiving the bobber assembly at each end thereof.

A bobber assembly is for use with a culling clip. The bobber assembly includes a bobber body operably attachable to a culling clip and a removably attachable bobber label.

A culling clip system includes a culling clip and a bobber assembly.

The culling clip system may further include a balance beam weigh scale.

Further features will be described or will become apparent in the course of the following detailed description.

### BRIEF DESCRIPTION OF THE DRAWINGS

The embodiments will now be described by way of example only, with reference to the accompanying drawings, in which:

FIG. 1 is a perspective view of a culling clip:

FIG. 2 is a top view of the culling clip of FIG. 1;

FIG. 3 is a front view of the culling clip of FIG. 1;

FIG. 4A is a side view of the culling clip of FIG. 1 shown in the open position;

FIG. 4B is a side view of the culling clip of FIG. 1 shown in the closed position;

FIG. 5 is perspective view of a culling clip body of the culling clip of FIG. 1;

FIG. 6 is a top view of the culling clip body of FIG. 5;

FIG. 7 is a perspective view of a thumb unlock slider body for use with the culling clip body of FIG. 5 of form culling clip of FIG. 1;

FIG. 8 is a top view of the thumb unlock slider body of FIG. 7;

FIG. 9 is a front view of the thumb unlock slider body of FIG. 7;

FIG. 10 is a side view of the thumb unlock slider body of FIG. 7;

FIG. 11 is a drawing of a large mouth bass;

FIG. 12 is a drawing of the culling clip of FIG. 1 used with a large mouth bass;

FIG. 13 is a perspective view of a marker bobber assembly for use with the culling clip of FIG. 1;

FIG. 14 is a perspective view a marker bobber of the marker bobber assembly of FIG. 13;

FIG. 15 is a side view of the marker bobber of FIG. 14;

FIG. 16 is a perspective view of a clip-on label for use with the marker bobber of FIG. 14;

FIG. 17 is a perspective view of a balance beam weigh scale for use with the marker bobber assembly of FIG. 13;

FIG. 18 is an enlarged perspective view of the bobber saddle of the balance beam weigh scale of FIG. 17;

FIG. 19 is a front view of the balance beam weigh scale of FIG. 13;

FIG. 20 is a front view of the balance beam weigh scale of FIG. 17 shown with the marker bobber assembly of FIG. 13;

FIG. 21 is a perspective view of the balance beam weigh scale of FIG. 17 shown with the culling clip of FIG. 1;

FIG. 22 is an enlarged perspective view of the bobber saddle of the balance beam weigh scale with the culling clip as shown in FIG. 21;

FIG. 23 is a perspective view of a storage bracket for use with the culling clips of FIG. 1;

FIG. 24 is an enlarged perspective view of the storage bracket of FIG. 23 shown with the culling clip of FIG. 1;

FIG. 25 is a perspective view of an alternate culling clip similar to that of FIG. 1;

FIG. 26 is a perspective view of a thumb unlock slider body used in the culling clip of FIG. 25; and

FIG. 27 is a front view of the thumb unlock slider body of FIG. 26.

### DETAILED DESCRIPTION

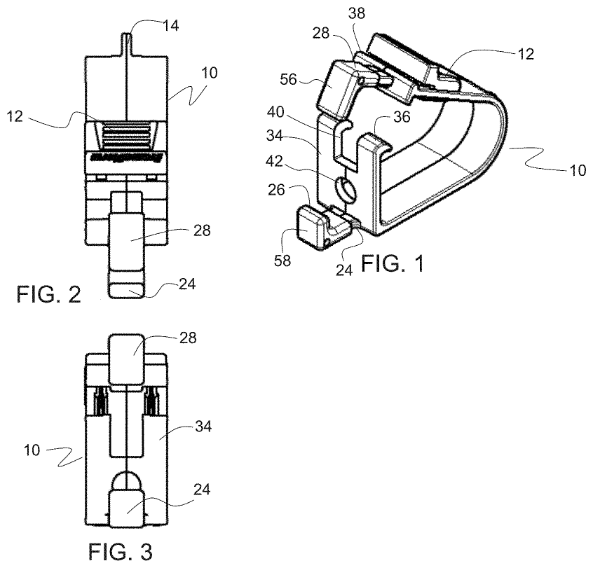

To meet the challenge of providing a culling clip and system for use therewith that is easy to use and reduces or eliminates injuries or harm to the fish the culling clip 10 shown in FIG. 1 and system for use therewith was developed. The culling clip shown herein is considered in the no-harm non-penetrating category of culling clips. As described below, culling clip 10 surrounds the lower jaw of the fish with a soft durable material thus ensuring the identification marker can be kept in place without harming the fish. The soft material covering of the culling clip arms prevent damage to the lower jaw or skin while maintaining a firm grip around the lower jaw bone of the fish. The compact size of the culling clip 10 allows an angler to use one hand to attach and remove the culling clip 10 while handling the fish with the other hand. The short length and small size of the Culling clip 10 prevents the fish from prying off the end of the clip when the clip is pressed against another object such as the livewell holding tank walls or another fish in the livewell. The thin size of the jaw clamping arms allows the fish to open and close its mouth for breathing.

Referring to FIGS. 1 to 4A and 4B, the culling clip 10 is a simple one-piece clip that holds around the lower jaw of the fish. A thumb slide tab 12 is added to aid in the releasing of the locking clasps when opening/removing the culling clip 10. Culling clip 10 has an attachment ring 14 so an identification marker can be attached thereto.

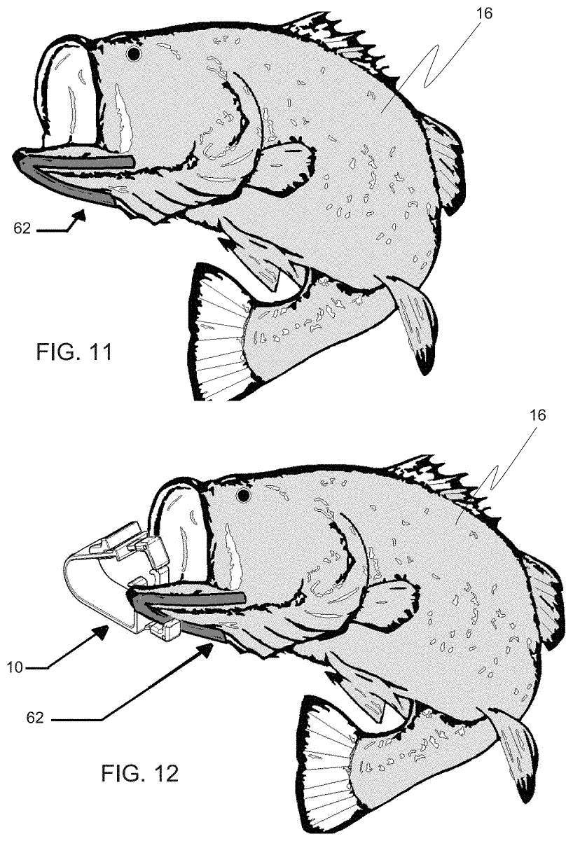

The design of the culling clip 10 allows an angler the ability to hold the fish with one hand, typically by grasping the lower jaw between the thumb and index finger or holding a gill plate, while the other hand positions the culling clip 10 around the lower jaw of the fish 16 as best seen in FIGS. 11 and 12.

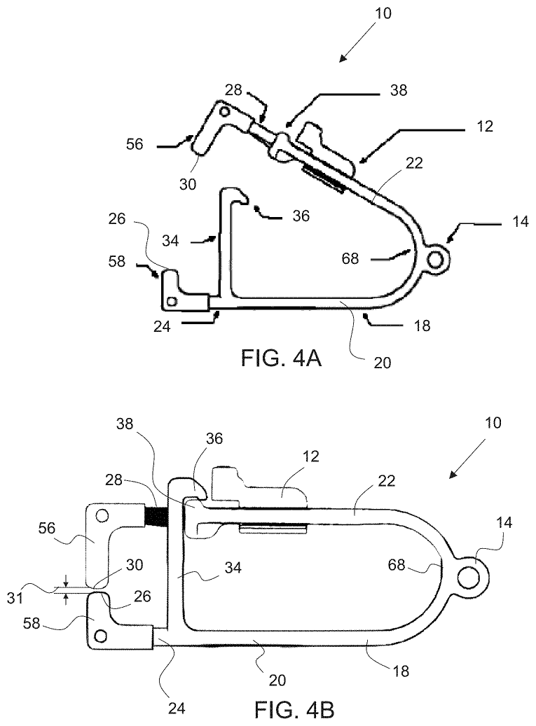

Culling clip 10 includes a culling clip body 18 having an open position and a closed position. The culling clip body 18 is a generally elongate C-shape with an upper arm 22 and a lower arm 20. A lower clamp arm 24 extends inwardly or upwardly from the end for the lower arm 20 and has a lower clamp arm distal end 26. An upper clamp arm 28 extends inwardly or downwardly from the end of the upper arm 22 and has an upper clamp arm distal end 30. The lower clamp arm distal end 24 is spaced from the upper clamp arm distal end 30 when the culling clip body is in the closed position as best seen in FIG. 4B. The gap 31 between the lower clamp arm distal end 24 and the upper clamp distal end is shown in FIG. 4B. The lower clamp arm 24 is shorter than upper clamp arm 28. A locking mechanism holds the culling clip body in the closed position.

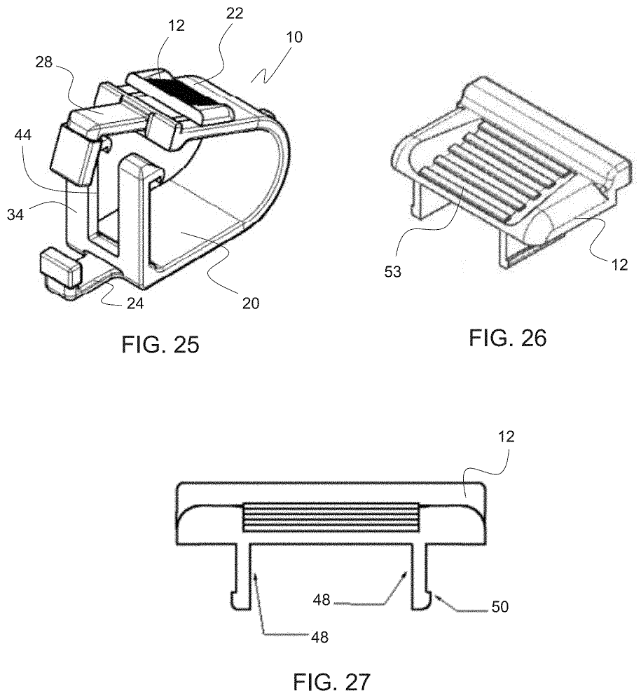

In the embodiment shown herein, the locking mechanism includes a locking clasp arm 34 and a thumb slide 12. The locking clasp arm extends upwardly from the lower arm 20 and includes a locking clasp 36 which engages a locking bar 38 formed in the upper arm 22. The locking clasp arm 34 is spaced inwardly from lower clamp arm distal end 26. The locking clasp arm 34 has a slot 40 formed therein greater than width of the upper clamp arm 28. A hole 42 may be formed in the locking clasp arm 34 below the slot 40. Slot 40 also serves to keep an angler from pushing the upper arm 22 and lower arm 20 too close together. In an alternate embodiment shown in FIG. 25 the slot is an elongate slot 44.

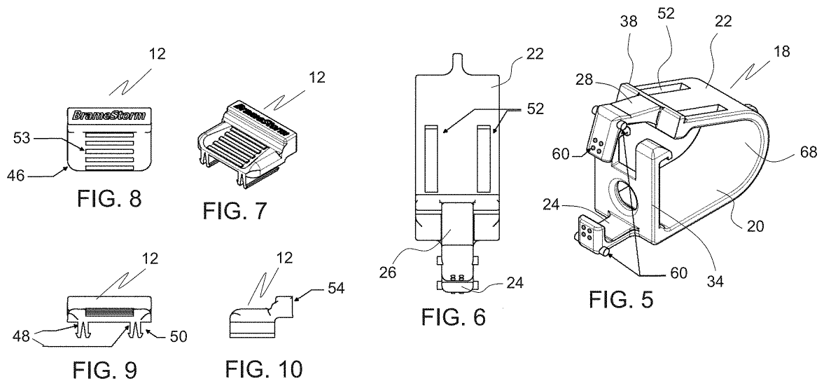

A thumb slide 12 is slidingly attached to the upper clamp arm 28 and is used to disengage the locking clasp 36 of the locking clasp arm 34 from the locking bar 38. The thumb slide 12 includes a slider body 46 and slide rails 48 extending downwardly. Each slide rail 48 includes a slide rail holding tab 50. In one embodiment there are two sets of spaced apart slide rails 48 as best seen in FIG. 9. In an alternate embodiment there are spaced apart slide rails 48 as shown in FIG. 27. Slide rails 48 are press fit into thumb slide slots 52 formed in upper arm 22 of culling clip body 18 as best seen in FIG. 5. The slide rail holding tabs 50 keeps the slide rails 48 from pulling out of the thumb slide slots 52. Thumb slide 12 is moveable forward and aft along the thumb slide slots 52. Slider body 46 has a plurality of thumb grip ridges 53 formed therein that enhance the user's ability to move the slider body 46 fore and aft along the thumb slider slots 52. Slider body 46 includes a thumb slide unlocking bar 54 which extends outwardly such that when the thumb slide is moved forward the thumb slide unlocking bar 54 engages the locking clasp 36 of the locking clasp arm 34 when the culling clip body 18 is in the closed position to move the clip body from the closed position to the open position.

The upper clamp arm 28 has an upper clamp arm soft material cover 56 and lower clamp arm 24 has a lower clamp arm soft material cover 58. The upper clamp arm soft material cover 56 and the lower clamp arm soft material cover 58 may be in the form of a sleeve. The lower clamp arm 24 and the upper clamp arm 28 may have a plurality of posts 60 extending outwardly therefrom to assist in holding the respective sleeves in place. The posts 60 may have different lengths as best seen in FIGS. 5 and 6.

The design of the culling clip 10 allows an angler the ability to hold the fish with one hand, typically by grasping the lower jaw between the thumb and index finger or holding a gill plate, while the other hand positions the culling clip 10 around the lower jaw of the fish. The culling clip 10 is then squeezed together moving the culling clip body 18 from the open position to the closed position and allowing the locking clasp 36 to engage and secure the lower clamp arm 24 and upper clamp arm 28 around the lower jawbone 62 of the fish 16 as best seen in FIGS. 11 and 12. The fish is then placed into the livewell holding tank for sorting and retrieval.

The distal end 26 of the lower clamp arm 24 and the distal end 30 of the upper clamp arm 28 are spaced apart in the closed position so that they do not fully close onto the fish's jaw or pinch the skin as best seen in FIG. 4B. The elasticity of the upper clamp arm soft material cover 56 and lower clamp arm soft material cover 58 allow distal ends 26 and 30 of the lower clamp arm 24 and upper clamp arm 28 respectively to be pressed against the fish's skin inside the jaw bone surrounding the lower jaw bone without damaging the skin, cartilage, or bone of the fish's mouth.

To move the culling clip body 18 from the open position to the closed position or to “Close” the culling clip 10, the culling clip body 18 is squeezed together thereby flexing the culling clip body arc 68 and the lower clamp arm 24 and upper clamp arm 28 are forced close together. The locking clasp arm 34 and locking clasp 36 are guided forward when the top arc of the locking clasp 36 is force around the underside of locking bar 38. When the lower clamp arm 24 and upper clamp arm 28 are brought close together the locking clasp 36 clears locking bar 38 and the flex of the locking clasp arm 34 pushes the locking clasp 36 back to the rear of the culling clip body 18 past the locking bar 38 locking the lower clamp arm 24 and upper clamp arm 28 in place.

To move the culling clip body 18 from the closed position to the open position or to “Open” the culling clip 10, the user may place their index finger inside the culling clip body 18, the thumb is placed on the thumb slide 12 with the tip of the thumb against the thumb grip ridges 53, the middle finger, the ring finger, and the little finger support the underside of the culling clip body 18. The user squeezes the top and bottom of the culling clip body 18 which separates the locking clasp 36 from contacting the locking bar 38. At the same time the thumb slide 12 is pushed forward to force the locking clasp 36 away from the locking bar 38. When the thumb slide 12 is pushed all the way against the locking bar 38 the user then slowly releases the squeezing force of the thumb and the middle fingers which allows the culling clip body arc 38 to open up in turn opening the gap between the lower clamp arm distal end 26 and the upper clamp arm distal end 30.

A rear circle attachment ring 14 provides an attachment point to connect identification marking system onto each culling clip 10. One such identification marker is a colored bobber attached with a string or flexible wire

The culling clip 10 can be created in various colors to act as a visual identification system. The culling clip 10 design is fully scalable to be manufactured in sizes that accommodate various fish species sizes.

The culling clip 10 is designed to reduce or prevent damage to the fish's mouth while ensuring that the angler can securely attach an identification system onto the fish while it is in the livewell or holding tank. Unlike other culling clip systems on the market today the culling clip 10 is designed to hold securely by surrounding the fish's lower jawbone and gently applying the soft rubber of the clamping arms to the skin of the lower jaw of the fish. Most other culling clip systems today work by pinching down onto the fish's skin that is located just inside of the lower jawbone. The focus of the culling clip 10 design is to ensure that there will be no damage to the skin, cartilage, or jawbone of the fish from using the culling clip.

The culling clip 10 may be sized for the average angler to use with one hand holding the fish's lower jaw and the other hand positioning, closing or opening the culling clip. The size of the culling clip 10 is relatively small in comparison to the other culling clip systems on the market today. This small size feature helps to ensure that the fish can swim and breathe while it is attached around the lower jaw. In the embodiment shown herein, the flat thin lower clamp arm 24 and upper clamp arm 28 design enables the fish to close its mouth with only a slight opening just like the fish typically hold their jaw while at rest when the fish's mouth is not forced open. However, the sizing of the arms and the gap may vary depending on the target fish.

The culling clip 10 is attached by the angler to the fish as follows;
a. Hold the fish by the lower jaw or gill plate
b. With the fish held in one hand the angler holds the open culling clip 10 with the other hand inserting the open clamp arms around the lower jawbone of the fish
c. When the angler has the culling clip 10 in position the angler then squeezes the culling clip body 18 until the two locking tabs slide past the locking bar of the top portion of the culling clip. This locks the upper and lower clamp arms in the closed position securing the culling clip 10 around the fish's lower jawbone.
d. While still holding onto the lower jaw of the fish as in step “a” the angler then places the fish into the livewell where the fish will be kept until it is retrieved.

The culling clip 10 is removed/opened by the angler of the fish as follows;
a. The angler holds the fish by grasping the lower jaw or grill plate (for fish with teeth) with one hand, with the other hand the angler holds the culling clip 10
b. Placing the thumb onto the thumb slide 12 the index finger inside the culling clip body 18 near the arc 68 and the middle, ring, and little fingers under the culling clip body 18
c. Squeezing the culling clip 10 until the locking tabs are free from the locking bar
d. Then the angler pushes the thumb release slider forward which pushes the locking tabs away from the locking bar
e. The angler then allows the culling clamp to spring open
f. When the clamp is open the angler removes the culling clamp from the fish's mouth and releases the fish as desired.

The culling clip 10 is made up of three parts, the main body 18, the thumb slide 12 and the soft material 56, 58 that covers the clamping jaws.

The culling clip is made from materials that are non-toxic to the fish. The culling clip body 18 is made from a resiliently deformable material and is designed such that the culling clip body returns to the open position when released. The materials have the properties that allow the culling clamp to stay secure to the fish's lower jaw while having the “Spring” property to stay open.

The culling clips 10 can be manufactured in various colors to act as identification markers of each culling clipped fish. The culling clamp jaw clamp ends are coated with a soft material enabling the secure locking around the fish's lower jaw while not damaging the fish's skin cartilage or jawbone. The back end of the culling clip body 18 has an integrated ring 14 to accommodate the attachment of various identification markers such as colored string, colored floating bobber that may or may not have weighing numbering system and/or but not limited to other type of marking/identification systems.

The culling clip 10 is scalable thus having the ability to be manufactured for various fish species and sizes.

The culling clip 10 may also be used as a system in association with one or more of a bobber assembly 70, a balance beam weigh scale 72 and a storage bracket 74.

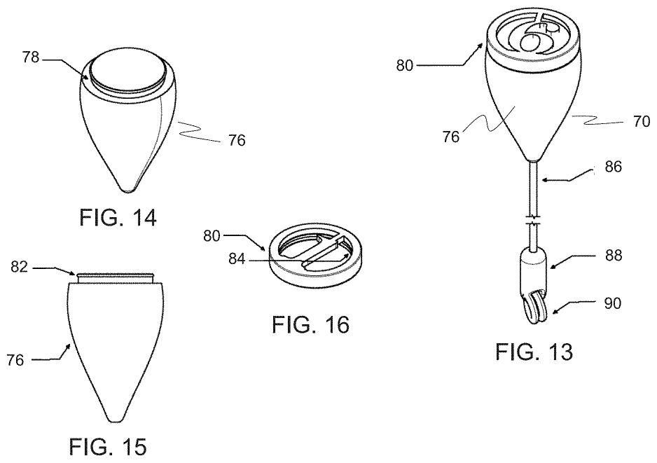

Referring to FIGS. 13 to 16, the bobber assembly 70 includes a bobber body 76, a lanyard 86 and an attachment device. In the embodiment shown herein the bobber body 76 is round when viewed from the top and tapered as it extends downwardly. The tapered shape serves to reduce the likelihood of the bobbers tangling with other bobbers attached to fish in the livewell. As compared to common round or other shaped bobbers, the tapered shape provides a relatively large volume for increased buoyancy and ease of visual identification while helping to reduce the likelihood of tangling. The bobber body 76 includes a bobber label seat 78 on which the clip-on bobber label 80 rests. The label seat 78 has a locking ring 82 for engaging or mating with a locking recess 84 formed in the bobber label 80. A lanyard 86 is attached to bobber body 76. The lanyard 86 has an attachment device at one end thereof. In the embodiment shown herein the attachment device includes a bobber lanyard attachment base 88 with a split ring 90 attached thereto.

The bobber assembly 70 allows the user to identify the item that is attached to the end of the lanyard 86. The bobber assembly 70 is attached to the culling clip 10 and allows the user to identify which fish is attached to the particular clip as the bobber marker is floating at or near the surface of the water in the livewell or water tank. The identification of each bobber assembly 70 is accomplished through coloring of the bobber body 76 or the clip-on bobber label 80 that has a number letter or other unique symbol. The taper of the lower portion of the bobber assembly 70 reduces or eliminates the tangling of the bobbers and lanyards. The tangling of the lanyards occurs when there are multiple fish swimming or moving within the water of the livewell or water tank. The gentle slope of the lower portion of the bobber body 76 reduces or prevents the lanyard or bobbers from creating an obtuse angle to each other and thus reduces the likelihood that the two or more lanyard bobbers do not become locked together. As stated earlier the tapered shaped body was designed to also have volume for buoyancy as well as visibility and ability to attach the glow-in-the-dark number clip.

The continuous flow of the lanyard to the bobber lanyard attachment base reduces or prevents the attachment points from creating the obtuse angle to each other or the bobber thus eliminating another point of entanglement. Since the fish have the culling clip 10 attached to the lower jaw the fish and clip act as one and tend to swim away from each other in a set horizontal position thus they avoid becoming entangled with in each other.

The clip-on bobber label 80 provides an added method for the user to identify the fish that is on the culling clip 10 via the bobber assembly 70. The clip-on bobber label 80 give the color blind the ability to identify a bobber with numbers or symbols. The clip-on bobber label 82 can also be coated with or manufactured with glow-in-the-dark material or fluorescent material and allow the user to clearly identify the bobber in low light or dark conditions. As well, the bobber body 76 may be manufactured from glow-in-the-dark material or fluorescent material.

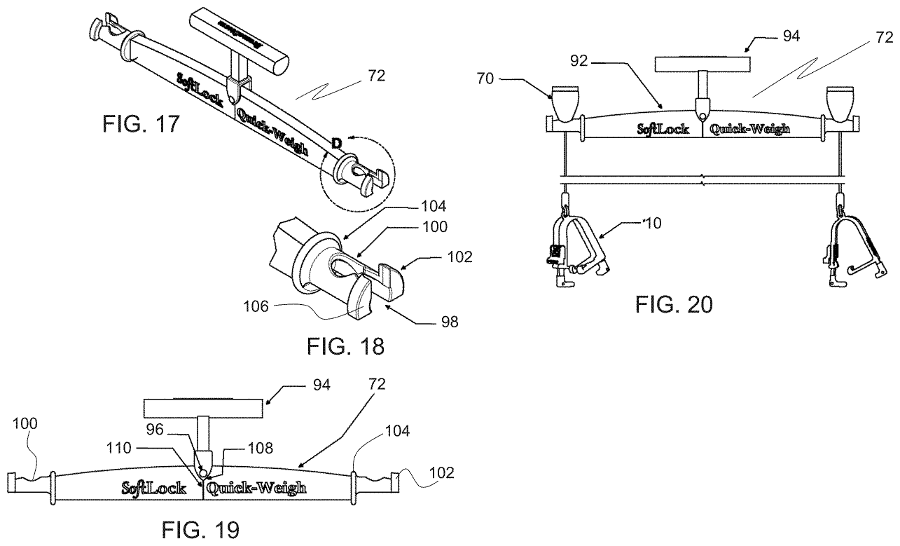

Referring to FIGS. 17 to 22, a balance beam weigh scale is shown generally at 72. The balance beam weigh scale 72 includes balance beam 92 and a handle 94 pivotally attached with an attachment pin 96. The handle 94 has a point at the end thereof to provide a handle indicator 108. The balance beam 92 has a beam indicator 110. Thus, when the weight at either end of the beam is equal, the handle indicator 108 and the beam indicator will be aligned. However, when the weight at one end does not equal the other the two indicators will not be aligned and will be pointed to the side of the beam with more mass.

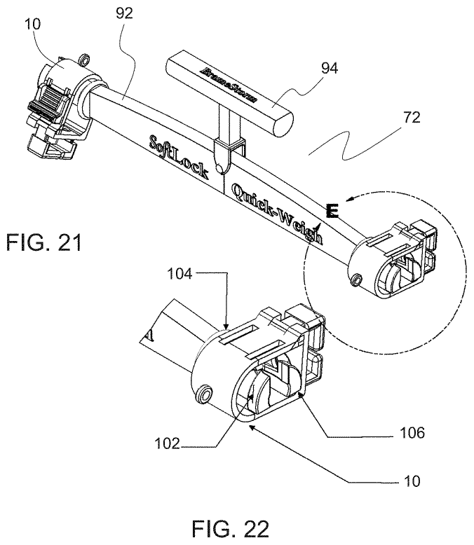

At each end of the balance beam there is a lanyard slot 98 and a bobber saddle 100. The lanyard slot 98 and bobber saddle are configured to receive the bobber assembly 70 as best seen in FIG. 20. At each of the balance beam 92 there is an outer ridge 102 and inner ridge 104 that define clip seat configured to receive the culling clip body 18 as best seen in FIGS. 21 and 22. The balance beam ends 106 are shaped such that when the culling clip 10 is oriented such that the upper arm 22 and lower arm 20 are generally 90° to the plane of the balance beam 92, the culling clip will fit over the end. In contrast when the upper arm 22 and lower arm 20 are generally parallel to the plane of the balance beam 92 the outer ridge 102 will hold the culling clip 10 in place.

The balance beam weigh scale 72 is a handheld balance beam that is used to quickly identify the heavier or two items, in this case two fish. The fish can be sorted in a number of ways with the balance beam. If the fish are on the culling clip 10, they are held onto the balance beam by turning the clip and beam 90° to each other so the clip can slide over the balance beam ends 106. The outer ridge 102 holds the clip 10 from sliding off the beam and the inner ridge 104 ensures the lighter fish does not slide towards the handle. The angler identifies the heavier fish when the handle indicator point 108 moves off of the beam indicator line 110 and to one side of the balance beam 92. To remove the culling clip 10 and fish the angler tilts the clip 10 and beam 92 in opposing directions to obtain a 90° difference. At that point the culling clip 10 can slide off the balance beam 92.

If the user wants to use the bobber assembly 70 to attach the fish which is on a culling clip to the balance beam weigh scale 72, the user guides the top end of the lanyard 86 into the lanyard slot 98 at the end of the balance beam 92 and sets the bobber body 76 into the bobber saddle 100 that is designed to hold the bobber body 76. As described above the angler identifies the heavier fish when the handle indicator 108 moves off of the beam indicator 110 and to one side of the balance beam. To remove the user secures the beam with one hand and lifts the bobber with the other hand while guiding the lanyard out of the lanyard slot. The bobber saddle 100 also allows the balance beam weigh scale 72 to work with the typical ball type bobber markers.

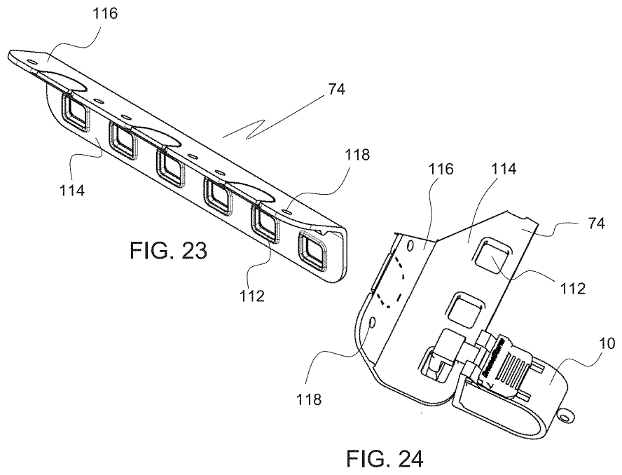

Referring to FIGS. 23 and 24, a storage bracket 74 may be used to organize a plurality of culling clips 10. The storage bracket 74 has a plurality of holes 112 formed therein for receiving the clamp arms 24, 28 of the culling clip 10. The culling clips 10 are set into the openings so the soft ends are not deformed nor are the arms deformed thus opening the gap between the soft tipped arms. The bracket may be generally L-shaped in profile having a clip receiving portion 114 and an attachment portion 116. The bracket is at a generally a 45 degree angle for ease of access as well as to hold the arms properly. The attachment portion 116 may have a plurality of screw holes 118 formed therein. The perforations and holes 118 are there to allow for easy attachment to the bottom of the livewell lid locking handle fastening screws. The other way of attaching is to screw into the underside of the livewell lid, screw onto a structure of the boat, or to use dual sided adhesive tape to simply stick the attachment portion on to a structure that is convenient for the angler. Generally speaking, the systems described herein are directed to culling systems. Various embodiments and aspects of the disclosure are described in the detailed description. The description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein the “operably connected” or “operably attached” means that the two elements are connected or attached either directly or indirectly. Accordingly, the items need not be directly connected or attached but may have other items connected or attached therebetween.

What is claimed is:

1. A culling clip for use with fish, comprising:
a culling clip body having an upper arm and a lower arm spaced from the upper arm, the culling clip body having an open position and a closed position;
a lower clamp arm extending inwardly from the lower arm at an end thereof, the lower clamp arm having a lower clamp arm distal end;
an upper clamp arm extending inwardly from the upper clamp arm at an end thereof, the upper clamp arm having an upper clamp arm distal end and wherein the lower clamp arm distal end is spaced from the upper clamp arm distal end when the culling clip body is in the closed position; and
a locking mechanism for holding the culling clip body in the closed position.

2. The culling clip as claimed in claim 1 wherein the culling clip body is generally elongate C-shaped.

3. The culling clip as claimed in claim 2 wherein the upper clamp arm is longer than the lower clamp arm.

4. The culling clip as claimed in claim 1 further including an upper clamp arm soft material cover over the upper clamp arm and a lower clamp arm soft material cover over the lower clamp arm.

5. The culling clip as claimed in claim 4 wherein the upper clamp arm soft material cover is a sleeve and the lower clamp arm soft material cover is a sleeve.

6. The culling clip as claimed in claim 5 wherein the upper clamp arm and the lower clamp arm each have a plurality of posts extending outwardly to hold the upper clamp arm soft material cover and the lower clamp arm soft material cover in place.

7. The culling clip as claimed in claim 1 wherein the locking mechanism includes a locking clasp arm that extends inwardly from one of the upper arm and the lower arm and engages the other of the upper arm and the lower arm and spaced inwardly from the lower clamp arm distal end and the upper clamp arm distal end and the locking clasp arm holds the culling clip body in the closed position.

8. The culling clip as claimed in claim 7 wherein the locking mechanism further includes a thumb slide for disengaging the locking clasp arm.

9. The culling clip as claimed in claim 1 wherein the culling clip body is made from resiliently deformable material and wherein the culling clip body returns to the open position.

10. The culling clip as claimed in claim 1 further including a bobber assembly attachable to the culling clip body.

11. The culling clip as claimed in claim 10 wherein the bobber assembly includes a bobber body and a removably attachable bobber label.

12. The culling clip as claimed in claim 11 wherein the bobber body is tapered as it extends downwardly.

13. The culling clip as claimed in claim 11 wherein the bobber label is one of glow-in-the-dark and fluorescent material.

14. The culling clip as claimed in claim 10 wherein the culling clip body includes an attachment ring and the bobber assembly includes a lanyard attached between the bobber body and an attachment device, and the attachment device is attachable to the attachment ring.

15. The culling clip as claimed in claim 14 wherein the bobber assembly attachment device includes a split ring.

16. The culling clip as claimed in claim 10 wherein the bobber assembly is attachable to a weigh scale.

17. The culling clip as claimed in claim 16 wherein the weigh scale is a balance beam weigh scale for determining the relative weight between two fish attached at either end of the weigh scale.

18. The culling clip as claimed in claim 17 wherein the balance beam weigh scale has a balance beam with a lanyard slot and bobber saddle for receiving the bobber assembly at each end thereof.

19. The culling clip as claimed in claim 1 wherein the culling clip body is attachable to a weigh scale.

20. The culling clip as claimed in claim 19 wherein the weigh scale is a balance beam weigh scale for determining the relative weight between two fish attached at either end of the weigh scale.

21. The culling clip as claimed in claim 20 wherein the balance beam weigh scale has a balance beam with a clip seat for receiving the culling clip body at each end thereof.

22. The culling clip as claimed in claim 21 wherein the balance beam further includes a lanyard slot and bobber saddle for receiving a bobber assembly at each end thereof.

23. A balance beam weigh scale for determining the relative weight between two fish attached at either end thereof, the balance beam weigh scale comprising;
a handle;
a balance beam pivotally attached to the handle such that the beam is equally balanced on either side of the pivot, the balance beam having a clip seat for receiving a culling clip at each end thereof.

24. The balance beam weigh scale as claimed in claim 23 wherein the balance beam further includes a lanyard slot and bobber saddle for receiving the bobber assembly at each end thereof.

25. A bobber assembly for use with a culling clip, the bobber assembly comprising:
a bobber body operably attachable to a culling clip; and
a removably attachable bobber label.

26. A culling clip system for use with fish comprising:
a culling clip having:
a body being general C shaped having an upper arm and a lower arm spaced from the upper arm, the culling clip body having an open position and a closed position;
a lower clamp arm extending inwardly from the lower arm at an end thereof, the lower clamp arm having a lower clamp arm distal end;
an upper clamp arm extending inwardly from the upper clamp arm at an end thereof, the upper claim arm having an upper clamp arm distal end and wherein the lower clamp arm distal end is spaced from the upper clamp arm distal end when the culling clip body is in the closed position;
a locking mechanism for holding the culling clip body in the closed position; and
a bobber assembly operably attachable to the culling clip.

27. The culling clip system as claimed in claim 26 further including a balance beam weigh scale.
